(19) United States
(12) Patent Application Publication
(10) Pub. No.: US 2009/0135205 A1
(43) Pub. Date: May 28, 2009

(54) DISPLAY METHOD FOR COLOR SEQUENTIAL DISPLAY

(75) Inventors: Cheng-Hung Wu, Tainan County (TW); Chia-Cheng Lai, Tainan County (TW); Kuan-Hsu Fan-Chiang, Tainan County (TW)

Correspondence Address: J C PATENTS, INC., 4 VENTURE, SUITE 250, IRVINE, CA, 92618, US

(73) Assignee: HIMAX DISPLAY, INC., Tainan County (TW)

(21) Appl. No.: 11/945,500

(22) Filed: Nov. 27, 2007

(51) Int. Cl. G09G 5/10

(52) U.S. Cl. 345/690

(57) ABSTRACT

A display method for a color sequential display is disclosed. The display method includes following steps. First, a frame is displayed by four color signals of a red signal, a green signal, a blue signal and a compensation signal. Next, a frame period is divided into eight subframe periods according to a sequence. Next, three of the said four color signals are selected and arranged in a sequence. And then, the selected three color signals are respectively displayed at the first, the second and the third subframe periods according to the sequence and respectively displayed at the fourth, the fifth and the sixth subframe periods according to the same sequence. After that, the unselected color signal of the said four color signals is displayed at the seventh and the eighth subframe periods.

### BACKGROUND OF THE INVENTION

1. Field of the Invention

The present invention generally relates to a display method for a display, and more particularly, to a display method for a color sequential display.

2. Description of Related Art

In a color sequential liquid crystal display (LCD), no color-filter is employed; instead, the cold cathode fluorescent lamp (CCFL) or the light emitting diodes (LEDs) of the backlight module (BLM) thereof are capable of emitting light with triple primary colors, i.e. light with red, green and blue colors, and suitable to quickly switch the light colors from one to another. The visual afterimage effect with human eyes during receiving external images provides an LCD with a possibility that by means of switching mono-color images from one to another in a high-frequency and a specific color sequence to make a full-color display perception. However, when the scheme is used to display dynamic frames, a color sequential display device likely generates color break up. To solve the above-mentioned problem, a higher frame rate for subframes is the major choice, which does not work all the time; in particular, the response speed limit of liquid crystals often makes above-mentioned scheme fail.

FIG. 1A is a conventional display sequence diagram to display subframes of a liquid crystal on silicon (LCOS) display. Referring to FIG. 1A, a full-color frame (taking a frame period of 1/60 sec, i.e. a frame rate of 60 fps) is divided into 6 subframes where each subframe takes a frame period of 1/360 sec, that is a corresponding color signal sequence of RGBRGB, . . . is obtained, wherein R, G and B respectively represent red signal, green signal and blue signal. In the prior art, the color break up phenomena can be lightened by using a shorter subframe period for all of R subframes, G subframes and B subframes. But the conventional scheme as above described can not eliminate the color break up, sometimes the color break up occurs seriously. Note that for a short subframe period of 1/540 sec (a frame rate of 540 fps), the response speed of liquid crystals is incompetent to follow the required subframe conversion speed.

FIG. 1B is another conventional display sequence diagram to display subframes of a liquid crystal on silicon (LCOS) display. Referring to FIG. 1B, the subframe display sequence in FIG. 1B is RRGGBB with a subframe period of 1/360 sec. FIG. 1B has a same color break up as FIG. 1A, but a different display sequence from FIG. 1A only.

### SUMMARY OF THE INVENTION

Accordingly, the present invention is directed to a display method for a color sequential display which is capable of lightening color break up phenomena and increasing the display luminance of a display device by inserting white subframes, and avoiding image sticking phenomena caused by a charge accumulation effect in a special display sequence.

The present invention provides a display method, wherein a frame is represented by four color signals including a red signal, a green signal, a blue signal and a compensation signal, said method includes the following steps. First, the frame period is divided into a first subframe period, a second subframe period, a third subframe period, a fourth subframe period, a fifth subframe period, a sixth subframe period, a seventh subframe period and a eighth subframe period. Next, three of the said four color signals are selected and arranged in a sequence. Next, the selected three color signals are respectively displayed at the first, the second and the third subframe periods according to the sequence and respectively displayed at the fourth, the fifth and the sixth subframe periods according to the same sequence. After that, the unselected color signal of the said four color signals is displayed at the seventh and the eighth subframe periods.

In an embodiment of the present invention wherein each of the color signals is alternately displayed in a positive and a negative polarity.

The present invention provides a display method for displaying a frame in a frame period, wherein the frame period comprises four bi-subframe periods, each of the bi-subframe periods comprises an odd subframe period and an even subframe period, said method includes following steps. First, a first color signal, a second color signal, a third color signal and a fourth color signal are selectively respectively displaying at each odd and even subframe periods, wherein each color signal is displayed in one odd subframe period of the bi-subframe periods with a first polarity and in one even subframe period of the bi-subframe periods with a second polarity, and at least one bi-subframe period includes two color signals to respectively display at the odd and the even subframe periods thereof.

The present invention provides a display method for a color sequential display for displaying a frame in a frame period, wherein the frame period comprises four bi-subframe periods, each of the bi-subframe periods includes an odd subframe period and an even subframe period, said method includes following steps. First, a first color light, a second color light, a third color light and a fourth color light are selectively respectively illuminating at each odd and even subframe periods, wherein each color light illuminates in one odd subframe period of the bi-subframe periods and in one even subframe period of the bi-subframe periods and at least one bi-subframe period includes two color lights to respectively illuminating at the odd and the even subframe periods thereof.

The present invention is capable of improving the influence of color break up, solving the problem of the prior art and promoting the display luminance of the display by inserting white subframes and increasing the frame rate of subframes. In addition, the present invention is able to avoid image sticking phenomena caused by a charge accumulation effect by using a special display sequence between the color signals.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a conventional display sequence diagram illustrating display subframes of a LCOS display.

FIG. 1B is another conventional display sequence diagram illustrating display subframes of a LCOS display.

FIG. 2 is a flowchart of a display method for a color sequential display according to a first embodiment of the present invention.

FIG. 3 is a diagram of a color signal arrangement sequence according to the first embodiment of the present invention.

FIG. 4 is a diagram of a color signal arrangement sequence according to the second embodiment of the present invention.

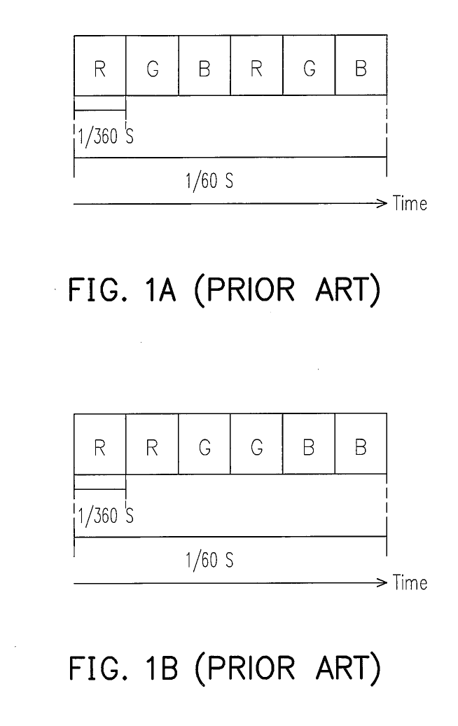

### DESCRIPTION OF THE EMBODIMENTS

### The First Embodiment

Reference will now be made in detail to the present preferred embodiments of the invention, examples of which are illustrated in the accompanying drawings. Wherever possible, the same reference numbers are used in the drawings and the description to refer to the same or like parts.

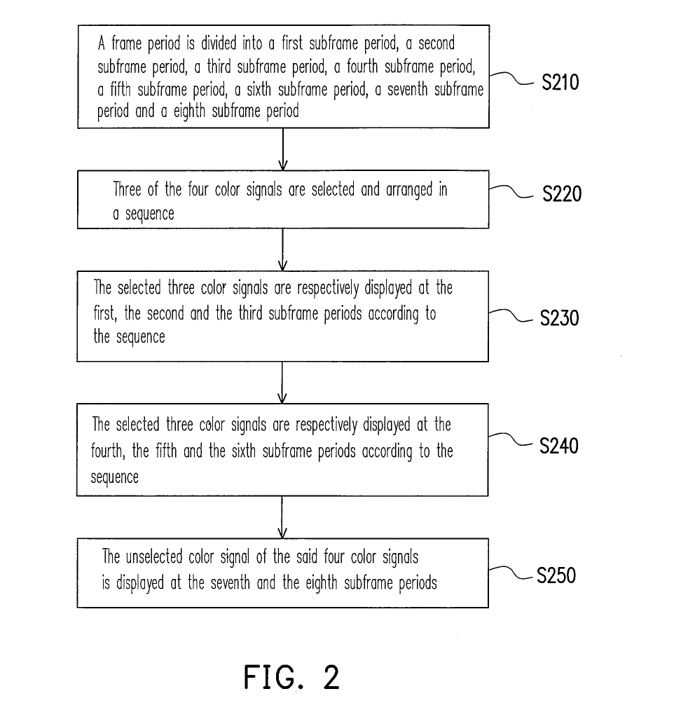

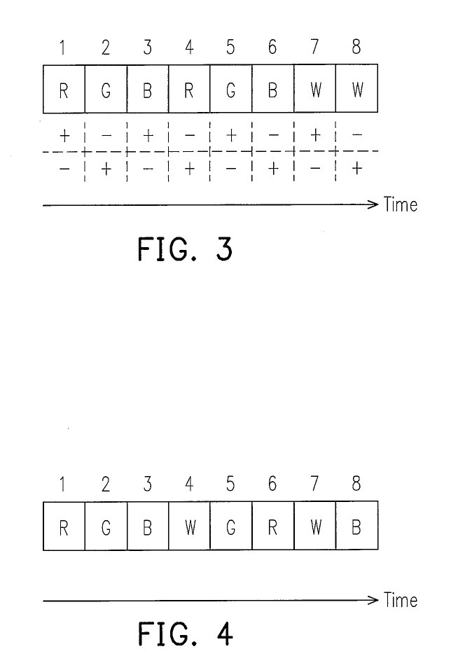

FIG. 2 is a flowchart of a display method for a color sequential display according to the first embodiment of the present invention. The display method is used for displaying a frame in a frame period, wherein the frame is represented by four color signals including a red signal, a green signal, a blue signal and a compensation signal. Referring to FIG. 2, in step S210, a frame period is divided into a first subframe period, a second subframe period, a third subframe period, a fourth subframe period, a fifth subframe period, a sixth subframe period, a seventh subframe period and a eighth subframe period. For example, subframe periods 1, 2, 3, 4, 5, 6, 7 and 8 as shown in FIG. 3, wherein 1-8 respectively represents a subframe period, and R, G, B, Ware respectively represent the red signal, the green signal, the blue signal and the compensation signal. In the present embodiment, the frame rate is, for example, 60 fps, i.e. the frame period of 1/60 sec. Besides, for the frame rate of 60 Hz and with eight subframes to represent a frame, the frame rate of every subframe is 480 Hz which correspond to a frame period of 1/480 sec.

Next, in step S220, three of the said four color signals are selected and arranged in a sequence. In step S230, the selected three color signals are respectively display at the first, the second and the third subframe periods. For example, the color signals R, G, B are displayed at the subframes periods 1, 2, 3 as shown in FIG. 3. Next, in the step S240, the selected three color signals are respectively displayed at the fourth, the fifth and the sixth subframe periods according to the same sequence. For example, the color signals R, G, B are displayed at the subframes periods 4, 5, 6 as shown in FIG. 3. After that, in the step S250, the unselected color signal of the said four color signals is displayed at the seventh and the eighth subframe periods. For example, the color signal W is displayed at the subframes periods 7, 8 as shown in FIG. 3.

In FIG. 3, the display sequence of the color signals for displaying the fourth, the fifth and the sixth subframes is the same as that for displaying the first, the second and the third subframes. Since the display sequence of color signals for the subframe periods 4, 5 and 6 is sequentially R, G and B as well. In other words, if the display sequence of color signals at the subframe periods 1, 2 and 3 is sequentially B, R and G, the display sequence of color signals at the subframe periods 4, 5 and 6 is sequentially B, R and G as well. Since three of the four color signals (R, G and B) are respectively displayed in the above-mentioned sunframe periods 1˜6, therefore, the compensation signal W is displayed at the subframe periods 7 and 8.

In the embodiment, the compensation signal W is a white signal, thus, the present invention is capable of effectively lightening color break up in the prior art and promoting the display luminance by inserting white subframes and increasing the frame rate of subframes. In addition, the compensation signal W can be other colors, for example, yellow signal, cyan signal or magenta signal which the present invention does not limit.

Note that, the driving polarity at the odd subframe periods and at the even subframe periods may be the same, which is able to result at a charge accumulation effect so as to generate image sticking effect. To solve the problem at the embodiment, the driving polarity is positive polarity at the odd subframe periods 1, 3, 5 and 7, and is negative polarity at the remaining even subframe periods 2, 4, 6 and 8; or contrarily, the driving polarity is positive polarity at the even subframe periods 2, 4. 6 and 8, and is negative polarity at the odd subframe periods 1, 3, 5 and 7. In this way, the polarities at the odd subframe periods and the polarities at the even subframe periods are able to be counterbalanced by each other, which certainly contribute to lighten the image sticking phenomena.

Note that the color signal arrangement sequence of RGBRGBWW is only one preferred embodiment, but not limited by the implementations of the present invention. In fact, other color signal arrangement sequences, for example, RBWRBWGG, GBWGBWRR or GRWGRWBB, are feasible as well. Anyone skilled in the art can deduce a preferred sequence referring to the above-mentioned flowchart, which is omitted to describe herein.

### The Second Embodiment

Referring to the above-mentioned embodiments, the present invention provides a Second embodiment corresponding to yet another display sequence, which has the same effect of reducing color break up and image sticking. In the embodiment, each frame period includes a plurality of bi-subframe periods and each of the bi-subframe periods further includes an odd subframe period and an even subframe period.

The first color signal, the second color signal, the third color signal and the fourth color signal are selectively respectively displayed at each odd and even subframe periods, wherein each color signal is displayed at one odd subframe period of the bi-subframe periods with a first polarity and at one even subframe period of the bi-subframe periods with a second polarity and at least one bi-subframe period comprises two color signals to respectively display at the odd and the even subframe periods thereof. In the present embodiment, the first and the second polarity are respectively a positive and a negative polarity.

Further, referring to FIG. 4 to explain the display sequence of the embodiment, FIG. 4 is a diagram of a color signal arrangement sequence according to the second embodiment of the present invention. First, assuming a frame period includes four bi-subframe periods, the odd subframe period and the even subframe period of the first bi-subframe period respectively correspond to the subframe periods 1 and 2 in FIG. 4. The odd subframe period and the even subframe period of the second bi-subframe period respectively correspond to the subframe periods 3 and 4 in FIG. 4; and analogically for the rest third bi-subframe period and fourth bi-subframe period. Therefore, the display sequence is RGBWGRWB, wherein in each the bi-subframe period two color signals are used to display at the subframe periods thereof.

Furthermore, in the embodiment, the color signals of an odd subframe period and an even subframe period are driven by two different polarities so as to reduce charge accumulation. In addition, the display sequence of bi-subframe periods needs to satisfy that at least one subframe period includes two color signals to respectively display at the odd and the even subframe periods thereof.

Note that the arrangement sequence of RGBWGRWB is one of display sequences of the present invention only. The present invention allows other arrangement sequences, for example, RBGWRBWG, GWBGRBWR or BRGWRBWG etc. Anyone skilled in the art can deduct a preferred sequence referring to the above-mentioned flowchart, which is omitted to describe herein.

### The Third Embodiment

Since a color sequential display usually displays subframes in different colors by changing the backlight color, and therefore, the present invention accordingly provides a display method for a color sequential display where subframes in different colors are displayed by changing the sequence of the backlight colors. In the present embodiment, the displaying period of an image frame includes a frame period, wherein each frame period includes four bi-subframe periods and each of the bi-subframe periods includes an odd subframe period and an even subframe period, and each odd subframe period and each even subframe period respectively correspond to a subframe.

Next, a first color light, a second color light, a third color light and a fourth color light are used to serve as the light sources of a color sequential display, wherein the color lights are corresponding to the color signals respectively, i.e. a red light, a green light, a blue light and a compensation light. The color lights are illuminated according to the display sequence of the color signals described in the first and second embodiment.

In other words, the display method can be sum up in following step. The first color light, the second color light, the third color light and the fourth color light are selectively respectively illuminating at each odd and even subframe periods, wherein each color light illuminates at one odd subframe period of the bi-subframe periods and at one even subframe period of the bi-subframe periods, and at least one subframe period includes two color lights to respectively illuminating at the odd and the even subframe periods thereof.

Furthermore, the first color light, the second color light, the third color light and the fourth color light are respectively a red light, a green light, a blue light and a compensation light, and provided by light emitting diodes. The compensation color light may be a white light, a yellow light, a cyan signal or a magenta light. Anyone skilled in the prior should be able to derive other details of the display method from the given disclosure present invention without any difficulty, so it is omitted to describe herein.

In summary, the present invention uses a white frame to be inserted into a frame originally displayed by triple primary colors (RGB) in the prior art, the frame rate of each subframe is promoted, the color break up of a display is improved and the display luminance is enhanced. In addition, a unique display sequence of the four color signals is used to respectively display an odd subframe and an even subframe, which is able to avoid image sticking caused by charge accumulation effect.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A display method for displaying a frame in a frame period, wherein the frame is represented by four color signals including a red signal, a green signal, a blue signal and a compensation signal, said method comprising:
dividing the frame period into a first subframe period, a second subframe period, a third subframe period, a fourth subframe period, a fifth subframe period, a sixth subframe period, a seventh subframe period and a eighth subframe period;
selecting three of the said four color signals and arranging in a sequence;
displaying the selected three color signals respectively at the first, the second and the third subframe periods according to the sequence;
displaying the selected three color signals respectively at the fourth, the fifth and the sixth subframe periods according to the sequence; and
displaying the unselected color signal of the said four color signals at the seventh and the eighth subframe periods.

2. The display method according to claim 1, wherein the displaying step further comprises:
alternately displaying the color signals in a positive and a negative polarity.

3. The display method according to claim 1, wherein the compensation signal is a white signal, a yellow signal, a cyan signal or a magenta signal.

4. The display method according to claim 1, wherein a frame rate of the frame period is 60 Hz.

5. The display method according to claim 1, wherein a frame rate of the subframe period is 480 Hz.

6. A display method for displaying a frame in a frame period, wherein the frame period comprises four bi-subframe periods, each of the bi-subframe periods comprises an odd subframe period and an even subframe period, said method comprising:
selectively displaying a first color signal, a second color signal, a third color signal and a fourth color signal respectively at each odd and even subframe periods,
wherein each color signal is displayed at one odd subframe period of the bi-subframe periods with a first polarity and at one even subframe period of the bi-subframe periods with a second polarity;
wherein at least one bi-subframe period comprises two color signals to respectively display at the odd and the even subframe periods thereof.

7. The display method according to claim 6, further comprising:
illuminating a first color light, a second color light, a third color light and a fourth color light for a light source according to the color signals respectively at each odd and even subframe periods.

8. The display method according to claim 6, wherein the first and the second polarity are respectively a positive and a negative polarity.

9. The display method according to claim 6, wherein the first color signal, the second color signal, the third color signal and the fourth color signal are respectively a red signal, a green signal, a blue signal and a compensation signal.

10. The display method according to claim 9, wherein the compensation signal is a white signal.

11. The display method according to claim 9, wherein the compensation signal is a yellow signal, a cyan signal or a magenta signal.

12. The display method according to claim 6, wherein a frame rate of the subframe period is 60 Hz.

13. The display method according to claim 6, wherein a frame rate of the subframe period is 240 Hz.

14. A display method for a color sequential display for displaying a frame in a frame period, wherein the frame period comprises four bi-subframe periods, each of the bi-subframe periods comprises an odd subframe period and an even subframe period, said method comprising:
selectively illuminating a first color light, a second color light, a third color light and a fourth color light respectively at each odd and even subframe periods,
wherein each color light illuminates at one odd subframe period of the bi-subframe periods and at one even subframe period of the bi-subframe periods;
wherein at least one subframe period comprises two color lights to respectively illuminating at the odd and the even subframe periods thereof.

15. The display method according to claim 14, wherein the first color light, the second color light, the third color light and the fourth color light are respectively a red light, a green light, a blue light and a compensation light.

16. The display method according to claim 15, wherein the red light, the green light, the blue light and the compensation light are provided by light emitting diodes.

17. The display method according to claim 15, wherein the compensation light is a white light.

18. The display method according to claim 15, wherein the compensation light is a yellow light, a cyan light or a magenta light.
